(19) United States
(12) Patent Application Publication
(10) Pub. No.: US 2014/0359644 A1
(43) Pub. Date: Dec. 4, 2014

(54) METHOD AND SYSTEM FOR PROVIDING AN INTERACTIVE SHOPPING CHANNEL

(71) Applicant: Rogers Communications Inc., Toronto (CA)

(72) Inventors: Vinay Kumar, Toronto (CA); Luojun Jin, Toronto (CA); Michael Webb, Milton (CA); Ping WANG, Toronto (CA)

(21) Appl. No.: 13/906,842

(22) Filed: May 31, 2013

(51) Int. Cl. H04N 21/478; H04N 21/2543

(52) U.S. Cl. CPC H04N 21/47815; H04N 21/2543
USPC 725/5; 725/60

(57) ABSTRACT

A method and system for providing an interactive shopping channel. A head-end server may be configured to access product information, to access customer information specific to a set-top receiver, and to process purchase requests. The head-end server can be used to generate metadata which can be associated with broadcast video of a shopping channel. The head-end server may be configured to extract data from video content of the shopping channel in order to generate the metadata. The head-end server is configured to send the video content and the metadata to a set-top receiver and other companion client devices. The client devices can be configured to receive and play the shopping channel video, as well as facilitate purchasing of one or more products shown by the broadcast video. A purchase transaction can be initiated from the client devices by sending a communication to the head-end server which references the metadata.

### TECHNICAL FIELD

At least some example embodiments relate to media content distribution and, more particularly, to methods and systems for broadcasting an interactive shopping channel.

### BACKGROUND

Shopping channels are typically television video broadcasts used to promote items for purchase by customers who are watching television. In some conventional systems, if a customer is interested in a product advertised by the shopping channel, the customer is required to direct his attention away from the television to order the product. For example, the customer can use a telephone to contact an operator to order the desired item, describe the item using the product number and desired options, provide all personal and shipping information, and then provide payment such as using a credit card, gift card, etc. This can be an arduous and cumbersome process, which may also be prone to errors and security concerns. This process can be multiplied by the tens of thousands of phone calls that are processed daily by the operator.

It would be advantageous to provide for a method and system that, in part, provides user interaction for a broadcasted shopping channel.

### BRIEF DESCRIPTION OF THE DRAWINGS

Reference will now be made, by way of example, to the accompanying drawings which show example embodiments, in which:

FIG. 1 diagrammatically shows a system for providing an interactive shopping channel in accordance to an example embodiment;

FIG. 2 diagrammatically shows, in block diagram form, an example client device to which example embodiments may be applied;

FIG. 3 diagrammatically shows an example video frame of a shopping channel, in accordance with an example embodiment;

FIG. 4 diagrammatically shows, in block diagram form, an example shopping interface page, in accordance with an example embodiment;

FIG. 5 illustrates a flow diagram of a method for broadcasting an interactive shopping channel, in accordance with an example embodiment;

FIG. 6 illustrates a flow diagram of a method for processing a purchase request, in accordance with an example embodiment;

FIG. 7 illustrates a flow diagram of a method for generating metadata from video content, in accordance with an example embodiment;

FIG. 8 illustrates another example video frame of a shopping channel, in accordance with an example embodiment; and

FIG. 9 illustrates another example video frame of a shopping channel, in accordance with an example embodiment.

Similar reference numerals may be used in different figures to denote similar components.

### DETAILED DESCRIPTION OF EXAMPLE EMBODIMENTS

In some example embodiments, there is generally provided a method and system for providing an interactive shopping channel. A head-end server may be configured to access product information, to access customer information specific to a set-top receiver, and to process purchase requests. The head-end server can be used to generate metadata which can be associated with broadcast video of a shopping channel. This can be used to facilitate purchases of one or more products which are currently being presented by the shopping channel broadcast, and/or products which have been previously presented on the broadcast. In some example embodiments, products which are scheduled to be broadcast by the shopping channel in the future also may be available for purchase. The head-end server may be configured to extract data from video content of the shopping channel in order to generate the metadata. The head-end server is configured to send the video content and the metadata to a set-top receiver and other companion client devices.

The client devices can be configured to receive and play the shopping channel video, as well as facilitate purchasing of one or more of the products shown by the broadcast video through user interface screens. The client devices are configured to receive and process the metadata from the head-end server. A purchase transaction can be initiated from the client devices by sending a communication to the head-end server which references the metadata.

In the following description, reference is made to a television channel for displaying of video. The channel can relate to analog channels or digital channels, depending on the particular application or embodiment. Some example embodiments may not be limited to video, and may be applicable to broadcasted media content or other media content that may be viewed or consumed by an end user.

In some conventional systems, if a customer is interested in a product advertised by a shopping channel, the customer is required to move from the television to order the product. The customer can telephone the operator to order the desired item, describe the item using the product number and desired options, provide all personal and shipping information, and then provide payment such as using a credit card, gift card, etc. This can be an arduous and cumbersome process, which may also be prone to errors and security concerns.

In some other convention systems, upon seeing the product on the television, the customer can order the product over the Internet by way of a web portal or e-mail. This can follow a similar process as above, but instead requires the customer to fill out various forms and fields to complete at least some of the above-noted information in order to complete the order.

Some example embodiments herein recognize that an existing shopping channel video content file can already contain fixed or static regions which can provide useful information such as product information. This can be, for example, shown as a side panel, banner, sidebar, etc. In some instances, data can be extracted from the static regions so as to generate metadata for the existing shopping channel video. For example, if an unrelated product is being shown in the video (e.g., the spokesperson's clothing, the table or stand which is displaying the product), those items may not need to be considered or may be irrelevant to the product.

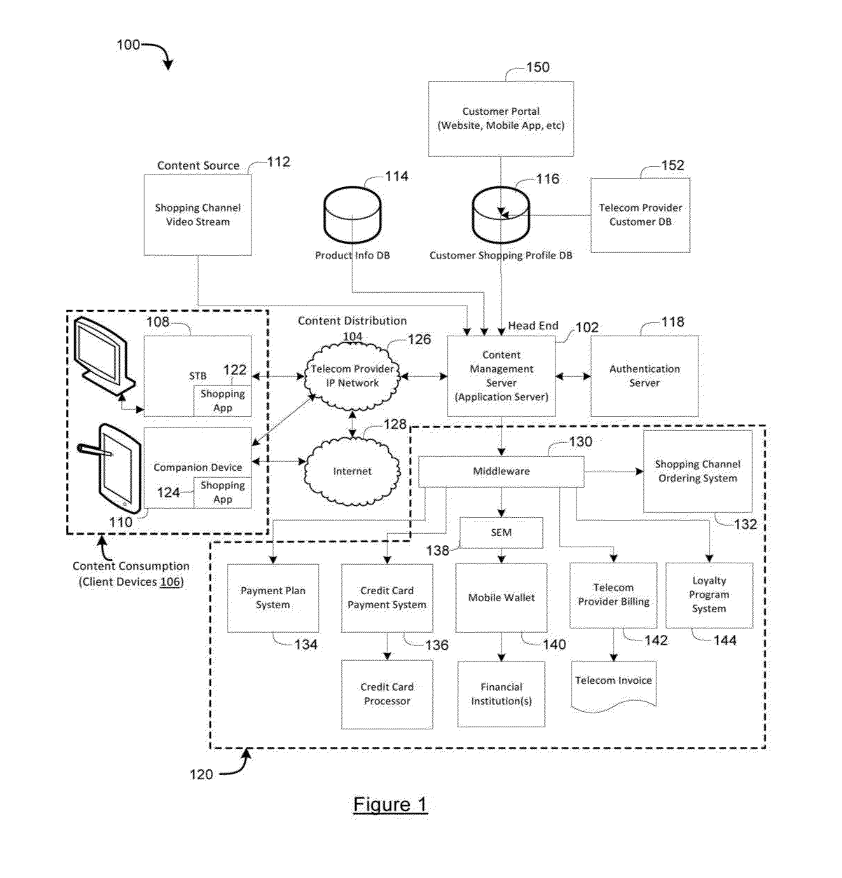

Reference is first made to FIG. 1, which shows a system 100 for providing an interactive shopping channel, in accordance to an example embodiment. Generally, the system 100 can be used to generate metadata which can be associated with broadcast video of the shopping channel. This can be used to facilitate purchases of one or more products which are currently being presented by the shopping channel.

In accordance with some example embodiments, the system 100 may be configured to extract data from video content of the shopping channel in order to generate the metadata. In accordance with some example embodiments, less information may be required to be input by the user to order a product, as some or all of the required information may already be available from the metadata or already known by the telecommunications provider.

In accordance with some example embodiments, the system 100 allows the customer to uniquely identify themselves and securely authenticate their identity. In accordance with some example embodiments, the system 100 allows the customer to self-declare preferences such as shipping address and payment methods and save these preferences for later use. In accordance with some example embodiments, the system 100 leverages back-end payment platforms to capitalize on existing customer account data and enable additional methods of payment.

Referring still to FIG. 1, the system 100 may include at least a content management server 102 (also referred to as head end server), a content distribution network 104, and client devices 106 for content consumption. The content management server 102 includes a shopping application server and has access to a number of further modules (e.g. applications, application servers, or databases), shown as content source 112, product information database 114, customer shopping profile database 116, authentication server 118, and payment processing 120. In some example embodiments, as shown, some of these further modules are separate modules and may even be remotely located and accessible through a communications network, such as an intranet or the Internet. In other example embodiments, at least one or all of these further applications may be included as a logical element within the head end server 102.

In some example embodiments, the head end server 102 is configured to electronically feed product information to the client devices 106, such as an application 122 on a consumer set-top receiver 108 (or “set top box”, “STB”), and/or an application 124 on a companion device 110. This allows the customer to order products using, for example, their handheld remote control and/or through the companion device 110 while watching the shopping channel video.

The content distribution network 104 can include an IP network 126 which includes a conventional telecommunications provider's content delivery network and/or any quality-of-service (QoS) guaranteed IP network. The content distribution network may also include the open Internet 128. In some example embodiments, both the content management server 102 and the IP network 126 are operated by the same telecommunications provider. In some example embodiments, the content distribution network 104 may be any type of service network or platform for video transmission, such as cable TV (ETV/Tru2way/GEM), IPTV, Mobile TV, etc. The configuration of the service networks, such as cable television, IPTV, Mobile TV, etc., would be understood to those skilled in the art. In some example embodiments, both the content source 112 (e.g. source of the shopping channel video) and the content management server 102 are operated by the same telecommunications provider.

Referring to the payment processing modules 120, this can include various modules which can be used to initiate or complete the payment transaction from purchases requested from the client devices 106. As illustrated in FIG. 1, the payment processing modules 120 include middleware 130, shopping channel ordering system 132, payment plan system 134, credit card payment system 136, secure element manager (SEM) 138, mobile wallet 140 (e.g. link to customer bank account), telecommunications provider billing 142, and loyalty program system 144. In some example embodiments, the telecommunications provider billing 142 is operated by the same telecommunications provider as the content management server 102 and the IP network 126, to readily facilitate payment processing, and to minimize reliance on outside parties.

Referring still to FIG. 1, the customer shopping profile database 116 can be accessed or modified through a customer portal 150 and/or from the telecom provider customer database 152. The customer shopping profile database 116 may include account information known to the telecommunications provider, customer authentication information, shipping information, and payment preferences. The customer shopping profile database 116 may include previous customer ordering history of products. Typically, the telecom provider customer database 152 has account information for customers which is at least associated with their particular set-top receiver 108, and/or other telecommunication account information such as mobile phone account, home phone account, and Internet broadband account.

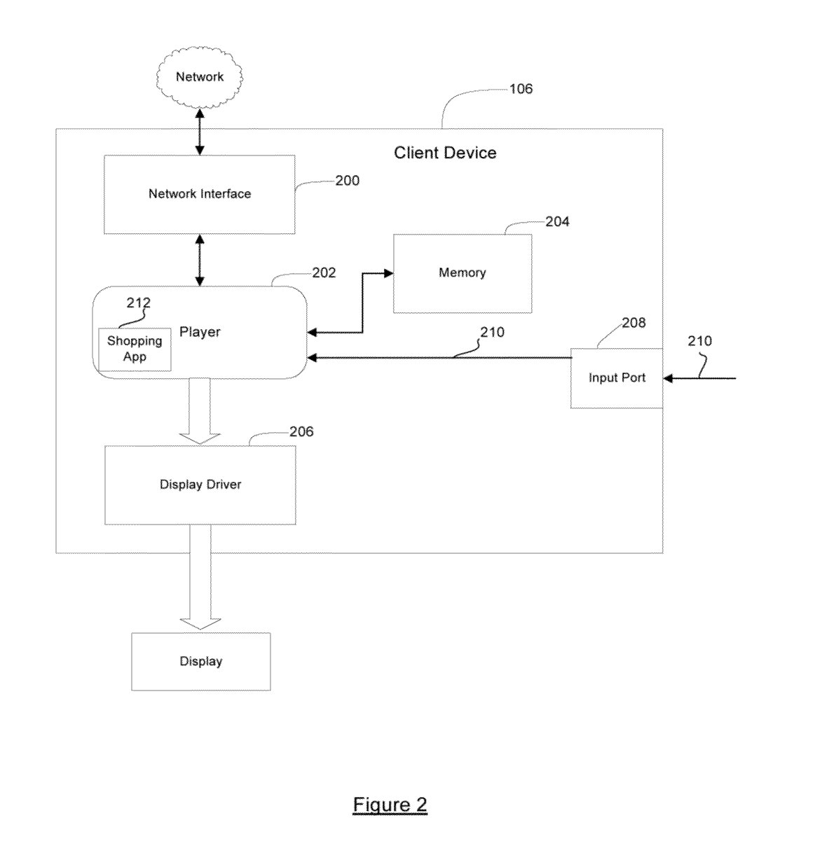

Reference is now made to FIG. 2, which illustrates an example client device 106 to which example embodiments may be applied. As shown, the client device 106 includes a network interface 200 and a player 202. The network interface 202 is configured to receive digital video transmissions from a remote source over a network, such as the content management server 102 (FIG. 1). The digital video may be packetized and transmitted to the client device 106 over an IP-based network in some embodiments. In some example embodiments, the received video transmission can comprise video content and metadata associated with the video content.

The player 202 is configured to receive the digital video transmission from the network interface 200 and output player video data. The client device 106 further includes a memory 204 which can include a buffer in which the player 202 stores reconstructed video frames until they are ready for output as player video data. The memory 204 can also be used to record received video transmissions such as through a personal video record (PVR) application, for subsequent access. The digital video transmissions received by the player 202 can be compressed, for example in accordance with MPEG-2 or H.264/MPEG-4 standards or other video compression standards.

In some instances, the client device 106 is an integrated or set-top television receiver 108 (“set-top box”) and the network is a broadcast network, such as a conventional wired cable television network or a satellite network. In some instances, at least some elements of the client device 106 may be implemented within the companion device 110, such as a computer or other computing device, and the network is an IP-based computer network, such as the Internet. In yet other instances, the client device 106 may be the companion device 110 in the form of a mobile device, tablet computer, laptop computer, or other computing device equipped with a wireless modem, and the network is a wireless network, such as a cellular network or wide area network (WAN), wireless local area network (WLAN), metropolitan area network (MAN), or other such wireless networks. In some example embodiments, the client device 106 is any computing device configured to receive a compressed video transmission, decode the compressed video, and output player video data. In some instances, the client device 106 may include an integrated display device, such as in a mobile device, tablet, laptop, etc., but in other instances, the client device 106 outputs the player video data to an external display device, such as a computer monitor or television set, through a display driver 206.

The client device 106 includes an input port 208 for receiving input commands 210 via an input device. The input port 208 and associated input device may include a touchscreen, infrared or Bluetooth™ remote control device, keyboard, keypad, trackball, mouse, or any other mechanism or device for receiving input from an external source, such as a user. In the embodiment shown in FIG. 2, the input commands 210 are relayed to the player 202 so that the player 202 may select and/or request the desired video, such as a channel change or video content retrieval. In a broadcast environment, the client device 106 may receive multiple streaming videos simultaneously, and the player 202 and/or network interface 200 may be configured to tune to the desired stream. It will be understood that the term “tune” does not necessarily means that the streams are frequency multiplexed, but that the network interface 200 and/or player 202 select data from the network relating to the desired stream. In this context, the player 202 and/or network interface 200 do not necessarily transmit a request for the desired video into the network. However, in other embodiments, such as in a video-on-demand or server-based environment, the client device 106 may be configured to transmit a request for the desired video to a server within the network in response to the input commands 210. In some instances, the input commands 210 may include selection of a video-on-demand title, request of a video from an online video source or service, or a channel selection request.

As shown in the example embodiment of FIG. 2, a shopping application 212 is provided or enabled with the player 202. The shopping application 212 may include instructions stored in the memory 204 or may be its own separate module. In some example embodiments, the input commands 210 are used to provide commands to the shopping application 212. The shopping application 212 may be configured to process received metadata, such as XML metadata or meta tags, that are associated with the received digital video transmissions. In some example embodiments, the input commands 210 are used to navigate through shopping interface pages and product order pages in order to place product orders through the client device 106.

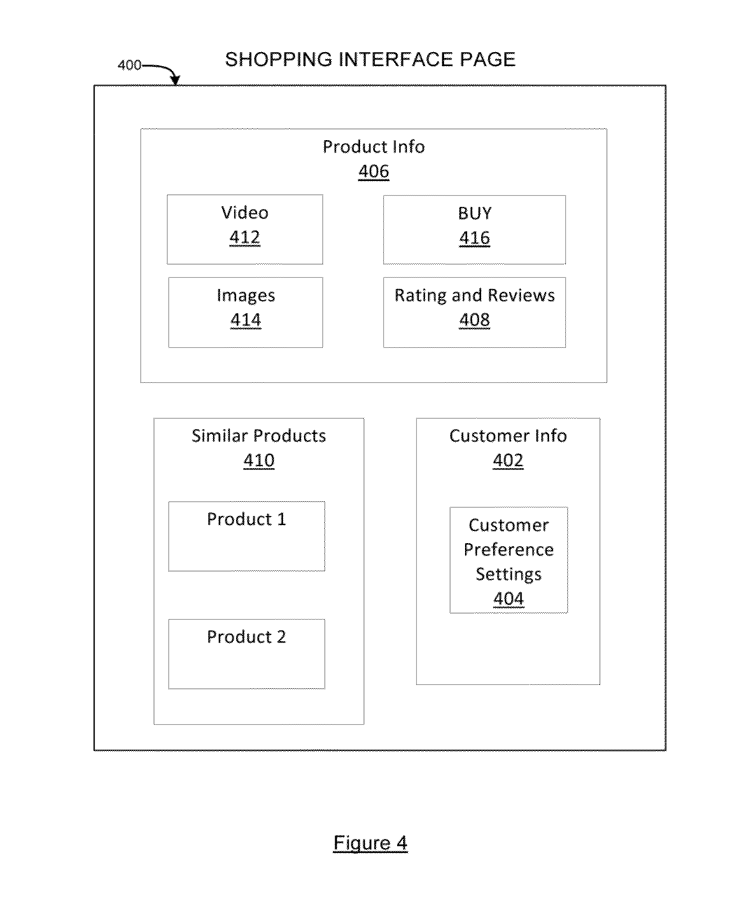

The shopping application 212 may be configured to display an interactive shopping interface page onto the display driver 206. This can be based on the received XML metadata. Additional information may be used or received in order to provide the shopping interface page. The shopping interface page may be provided on its own screen between breaks in programming of the video content, or on a separate window or overlay along with the video content. Reference is briefly made to FIG. 4, which illustrates an example shopping interface page 400.

Referring still to FIG. 2, the shopping application 212 is also configured to receive and process received input commands 210 from the user. For example, this can be used by the consumer to select icons or options which are displayed on the shopping interface page. For example, this can be used by the consumer to initiate a shopping transaction in order to purchase a desired product that is currently being displayed from the shopping video content.

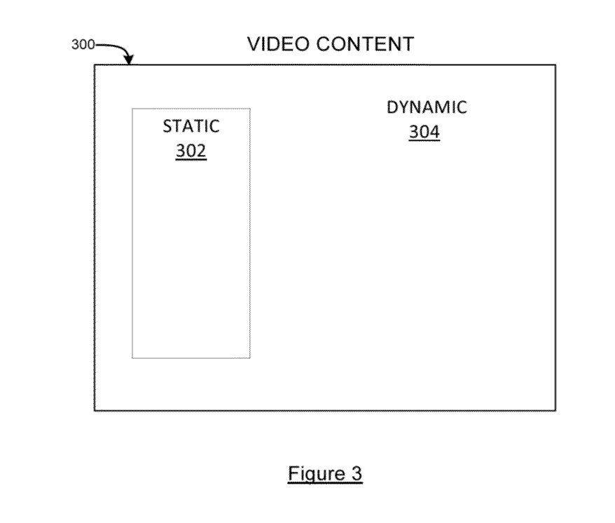

Reference is now made to FIG. 3, which illustrates an example video frame 300 of a displayed shopping channel video, in accordance with an example embodiment. The video frame 300 may include video content, which is the actual video being transmitted, as opposed to the metadata. In some example embodiments, the video content can be analyzed by the content management server 102 (FIG. 1) as having a static component 302 and a dynamic component 304. The static component 302 can be identified as a static region such as a side panel (as shown), banner, overlay, etc., of the video content. The static component 302 is a reserved area commonly found in shopping channel content which can contain product information. The static component 302 is an area which typically does not change over the course of the video content, or alternatively only periodically changes. In some examples, the static component of the video content displays some static product information for a period of time, and then displays other product information for that product for another period of time, etc. For example, the video content provided by the original content source 112 (FIG. 1) may be intend to have the static component display important product information to the viewer or customer which remains on the screen for at least a lasting period of time (e.g. at least 30 seconds).

The static component 302 can be determined by comparing consecutive video frames of a video file, and by determining that certain regions of the video content do not change or only change periodically. After this determination is made, data can be extracted from the determined static component 302, such as images or text using optical character recognition (OCR). In some example embodiments, this can be performed at the head end by the content management server 102 (FIG. 1).

The dynamic component 304 is also part of the video content, and is typically dynamic video in relation to the product being offered. For example, the video may include a spokesperson demonstrating the product for sale.

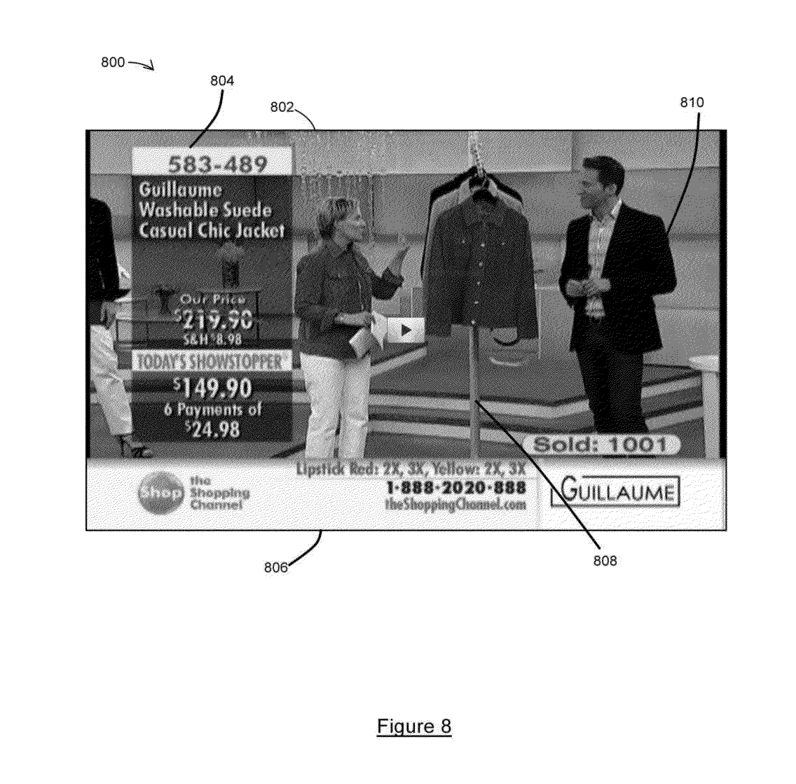

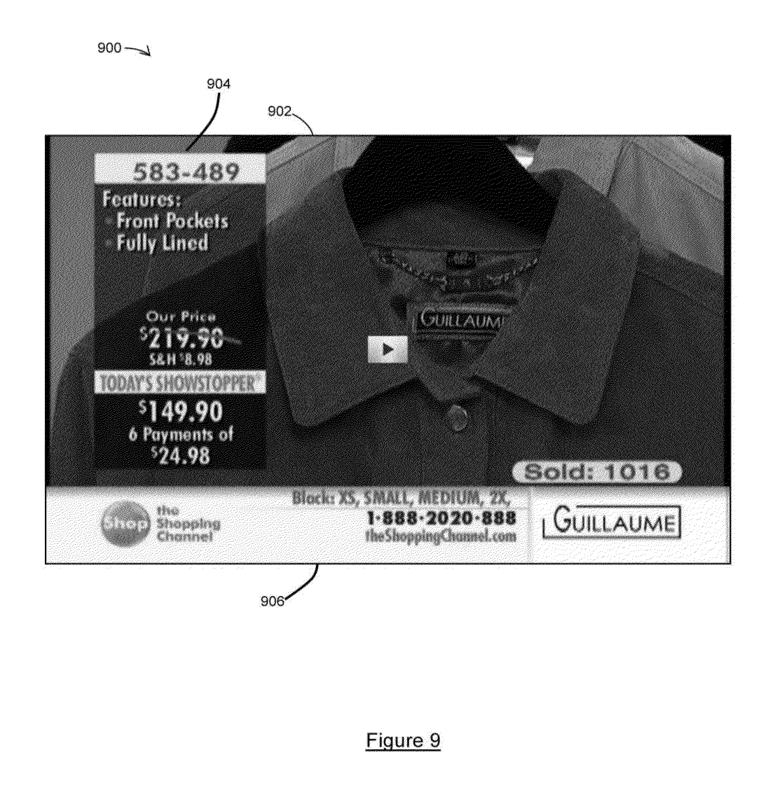

In order to further illustrate the shopping channel video content, reference is now briefly made to FIGS. 8 and 9, which illustrate example video frames 800, 900 of a displayed shopping channel, in accordance with an example embodiment. The video content is typically received as a video file at the content management server 102 from the content source 112. The illustrated frames 800, 900 are part of the same video content file. The video file may or may not already contain some metadata as populated by the content source 112. As shown in FIG. 8, the original video frame 800 may include a dynamic component 802 (e.g. of the actual video for the product) as well as a static component 804, shown as a side panel of the source video. The static component 804 of the source video may contain product information visible to the customer.

The side panel is illustrated in FIG. 8 as being a transparent overlay over the dynamic component 802. In other example embodiments, the side panel is opaque. In some example embodiments, the side panel may be in its own window. As shown, other static components may be displayed, such as bottom banner 806.

Referring to FIG. 9, the original video frame 900 can be subsequent to the previous video frame 800, e.g. 30 seconds later. As shown, the dynamic component 902 displays the actual video. The static component 904 of the video displays static product information of the same product, but can change periodically (e.g. every 30 seconds, for example). In some videos, the static component 904 may disappear momentarily from time to time, depending on the original video. Similarly, the bottom banner 906 can display different production information of the same product than in the previous bottom banner 806.

Again, the static components 904 are part of the original video content file. In some example embodiments, the content management server 102 can be configured to extract product information from the video content by determining or identifying the location of the static component 904. For example, referring to FIG. 8, as shown in the dynamic component 802, the display stand 808 or the spokesman's suit 810 may not be a product that is for sale in this example, and so extracting information from those elements may not provide any useful product information and may be a waste of resources. More accurate product information may be obtained by focusing on the static component(s) 804 of the original video content.

Referring still to FIG. 8, in some example embodiments, the content management server 102 can be configured to extract data from the static component 804. For example, optical character recognition (OCR) can be used to extract text images that are contained in the static component. In some example embodiments, an image of the product (not shown) may be contained in the static component 804, which can also be extracted from the video frame as an image file. In another example, referring to the bottom banner 806, the company logo “GUILLAUME” can be an image identified from a static region that is extracted. For example, other non-product images also may be extracted. The extracted image(s) may be referenced by the generated metadata for the product. In some example embodiments, the extracted text data can be used as a starting point to find more comprehensive information from the product information database 114 (FIG. 1), or from other sources such as an external official vendor website. Once suitable information is found, the content management server 102 can generate metadata of the production information for tagging the original video content file and/or sending with the video transmission.

Reference is now made to FIG. 4, which illustrates an example shopping interface page 400, in accordance with an example embodiment. In some example embodiments, the shopping interface page 400 may be generated from the content management server 102, the client device 106, or a combination thereof. The shopping interface page 400 is typically customized for a specified product, such as the product being presently shown in the video broadcast or the product that was just shown (when the shopping interface page is inserted between video segments). In some example embodiments, the shopping interface page 400 is customized by the content management server 102 based on at least the customer information and the product information of the product. In some example embodiments, the shopping interface page 400 may be shown by the client device 106 in a window which replaces the presently shown video content window (i.e. stopping showing of the present video). In some example embodiments, shopping interface page 400 may be shown in its own window adjacent or overlaying to the video content, wherein displaying of the present video is maintained by the client device 106.

Each block of the shopping interface page 400 may comprise displayed information in relation to that block and/or a user selectable option in relation to that block (e.g. by selecting that block using an input device such as remote control). In some example embodiments, the shopping interface page 400 may include at least some or all of customer information 402, customer preferences settings 404 such as billing information and shipping information, product information 406 such as product name and price information, product rating and/or reviews 408 from other purchasers or validated reviewers, other products such as similar products 410 or previous products, video segment request 412 of the product, and image(s) 414 of the product. Through the shopping interface page 400, the customer can navigate using the client device 106 to purchase one of the products.

For example, the customer can select the “BUY” button 416 to initiate a purchase transaction for that product. This results in a product order page being displayed (not shown), which has a plurality of fields. In other example embodiments, the product order page can be pulled up when displaying the main video content, by selection of a specified key on the remote control such as a “pay” key or a reserved key (e.g. A, B, or C keys) which may directly result in the product order page so that the customer can readily purchase the product. Some or all of the fields may be pre-populated in the product order page.

The similar products 410 may be e.g. those with the highest rating and/or the last number of broadcasted products of the same type as the current product, or other factors. Selection of one of the similar products 410 may also result in display of a similar customized shopping interface page 400, wherein that product become the primary product with similar blocks as in the shopping interface page 400.

In an example embodiment, selection of the video segment request 412 results in the particular video segment (e.g. 20 minute segment) for that product being played by the client device 106. The image(s) 414 may display a sample image of the product, wherein selection of the image(s) 414 box may display additional associated images and views of the product. The image(s) 414 may include extracted static images from the video content and/or more “official” images from the product information database 114.

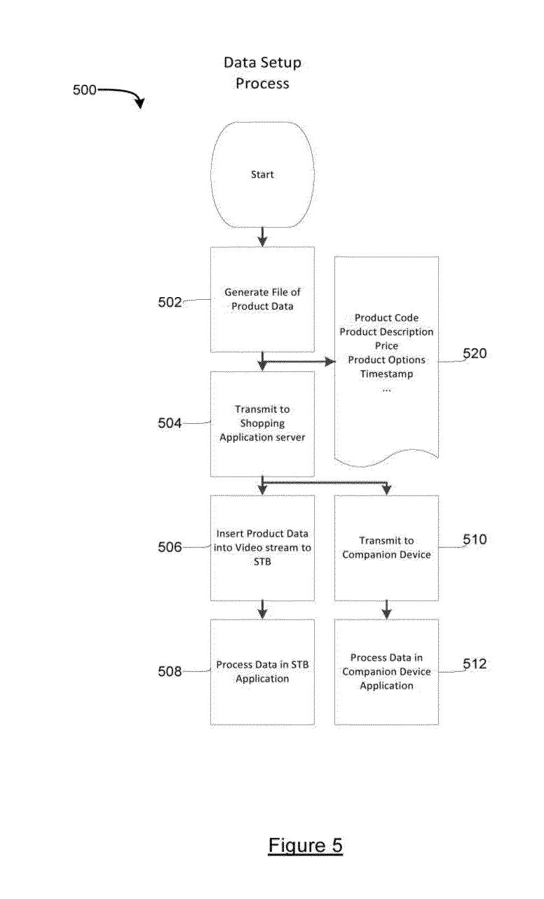

Reference is now made to FIG. 5, which illustrates a flow diagram of a method 500 for broadcasting an interactive shopping channel, in accordance with an example embodiment. At event 502, the content management server 102 generates a file of product data. As indicated at event 520, the product data file can include Product Code, Product Description, Price, Product Options, Timestamp, etc. The product data file can be in the form of a metadata file or meta tags.

At event 504, the content management server 102 transmits the metadata file to the shopping management server (e.g. can be a separate logical entity to the content management server 102). At event 506, the content management server 102 sends the product data file and the video content to the set-top receiver 108. In some example embodiments, this can include tagging the video content with the metadata. In some example embodiments, this may include sending the metadata as a separate file to the video content. In some example embodiments, the video and metadata are sent in a digital broadcast format such as MPEG-2. In other words, the video content and metadata may not be specifically tailored to any particular client device 106 at this stage.

In example embodiments, the video content may be sent as a video broadcast, as an entire video file, or as individual video segments. In some example embodiments, the metadata file is sent to the set-top receiver 108 during windows of opportunity, such as a commercial break or other transition.

At event 508, the product data file is processed by the shopping application 122 of the set-top receiver 108. At event 510, the video content and the metadata may also be sent to the companion device 110. At event 512, the product data file is processed by the shopping application 124 of the companion device 110.

The set-top receiver 108 may now be configured to enable purchasing requests from the user through an input device such as a remote control. For example, the set-top receiver 108 may subsequently send a communication to the content management server 102 which references the metadata in order to purchase one of the products. The communication may reference the time of the video which is currently being shown to the customer. The communication may reference product information which identifies the product that is currently being shown to the customer, such as the Product Code. By referencing the metadata, there is less opportunity for input errors as to the particulars of the product being ordered by the customer. The purchase request can be received from the set-top receiver and/or the companion device 110. In some example embodiments, in response to receipt of the purchase request communication, the content management server sends information for a custom shopping interface page to the set-top receiver 108, as illustrated by the shopping interface page 400 of FIG. 4. In some example embodiments, the set-top receiver 108 uses a combination of the received information and the previously received metadata in order to generate and display the shopping interface page 400.

In some example embodiments, in response to receipt of the purchase request, the content management server 102 sends information for a custom order page (not shown) to the set-top receiver 108. In some example embodiments, the information for the custom shopping interface page 400 may also be sent to the companion device 110.

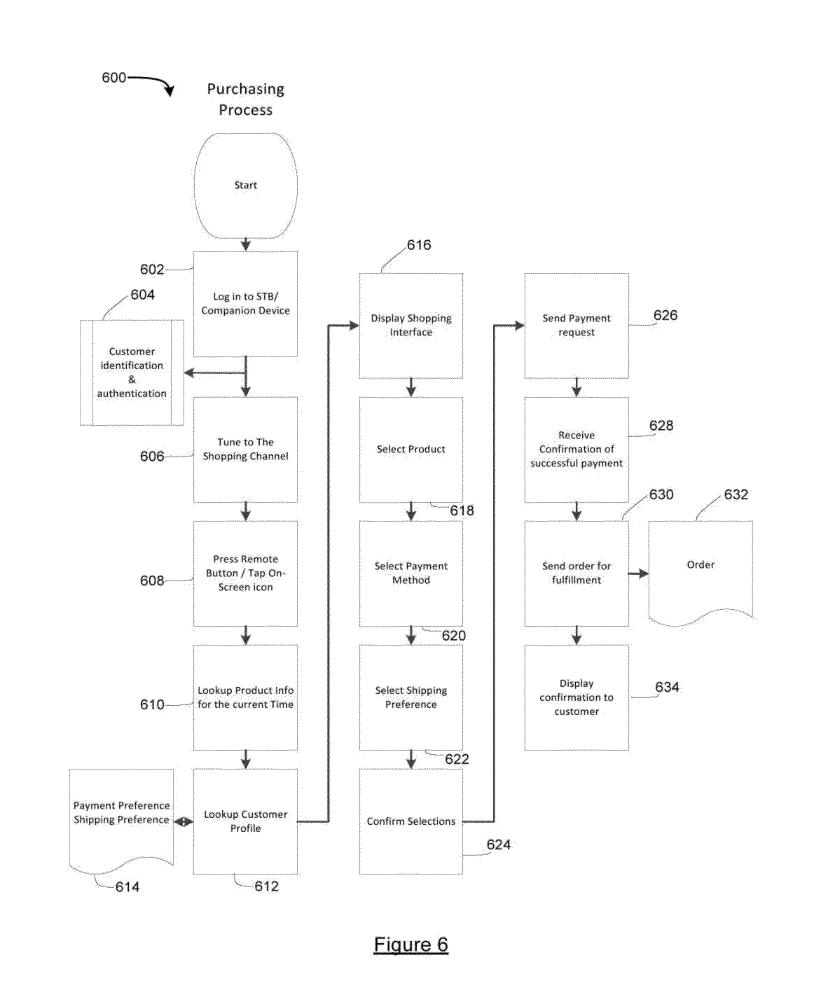

Reference is now made to FIG. 6, which illustrates a flow diagram of a method 600 for processing a purchase request, in accordance with an example embodiment. Generally, input commands can be entered into the client device 106 by the customer, in order to initiate a purchase transaction. The client device 106 would then communicate with the content management server 102 by referencing the metadata. There is less opportunity for input errors as to the particulars of the product being ordered by the customer. In response, the content management server 102 can send information to generate an interactive shopping channel page to the requesting the client device 106.

At event 602, the customer logs in through the set-top receiver 108. This can include a login interface screen executed from the shopping application 122 that requires a user name and a password, for example. The set-top receiver 108 may send the received login information to the content management server 102 for authentication. This can include requesting from the customer a mobile device account number or cable television/Internet account number of the telecommunications provider, for example. Some of the authentication information may be stored within the customer shipping profile database 116 (FIG. 1). Once signed in, security processes such as Single Sign-On (SSO) may be implemented.

At event 604, the customer information is authenticated by the authentication server 118, with the content management server 102 providing an appropriate response to the set-top receiver 108. At event 606, the customer changes the channel to the shopping channel through the set-top receiver 108. In some example embodiments, the relevant metadata for the presently shown shopping channel video is received by the set-top receiver 108 only when the channel is changed to the shopping channel. In other example embodiments, the metadata is received by the set-top receiver 108 at other times, such as in response to authentication by the authentication server 118 (event 604). In other example embodiments, the metadata is sent automatically with the shopping channel video, such as continuously sent or during suitable breaks in programming or channel changes.

In some example embodiments, the metadata is sent “on demand”, when the purchaser presses a suitable input command such as “PAY”, wherein the request is sent by the client device 106 to the content management server 102 to request metadata relating to items available for purchase, and in response the content management server 102 sends back the relevant metadata pertaining to the presently shown video to the client device 106. In some example embodiments, only some or partial metadata information is automatically sent by the content management server 102 to the set-top receiver 108 as part of the video stream (or, for example, during suitable breaks), such as Product Code. The remaining metadata information meanwhile is sent by the content management server 102 “on demand” (upon request), for example information such as Reviews or Rating information for the presently shown product.

At event 608, the customer uses an input device to initiate a purchase transaction command to the set-top receiver 108. For example, the option can be initiated by navigating using an input device, or using a suitable button such as a “PAY” button, or one of A, B, or C buttons for some remote controls that have such buttons. The set-top receiver 108 then provides a corresponding communication to the content management server 102. In some example embodiments, the communication includes a reference to the metadata of the currently viewed shopping channel program. This can include referring to the Product Code or Timestamp of the video.

At event 610, upon receipt of the purchase transaction, the content management server 102 looks up the product information for the current time or the Timestamp referenced in the received communication. In other example embodiments, the content management server 102 looks up the product information based on the referenced metadata.

At event 612, the content management server 102 looks up the customer profile from the customer shopping profile database 116. At event 614, this can include accessing predetermined or pre-specified payment preferences and shipping preferences for the particular customer.

At event 616, the content management server 102 sends information to the set-top receiver 108 for a custom shopping interface page in relation to the desired product. For example, this may include sending information accessed from event 614. The custom shopping interface page may include at least one or all of: the customer information, billing information, product information of one of the products, product rating, similar product information, previous product information, video segment request of the one of the products, and a selectable purchasing option. An example shopping interface page 400 is described above with respect to illustrated with respect to FIG. 4.

In some example embodiments, the shopping application 122 of the set-top receiver 108 assembles the information from the content management server 102 with the previously received metadata, in order to generate the shopping interface page. This can include markup information or one or more markup language documents, such as XML or HTML. In other example embodiments, the content management server 102 generates one or more markup language documents and sends to the set-top receiver 108.

A remote control input command may still be used during the video broadcast, to manually pull up the shopping interface page. In some example embodiments, the custom shopping interface page is automatically inserted between each video segments once the product showing is completed. The shopping interface page may be automatically display by the set-top receiver 108 between sequential videos of the video content. The shopping page may stay for a predetermined time period, for example 30 seconds. Once that time expires, the next video segment for the next product may be shown. If any suitable user input is received within the predetermined time period, the shopping page may be maintained (not expire) so that the user can navigate through the shopping interface page to purchase products or configure personal settings, etc.

At event 616, the set-top receiver 108 displays the shopping interface page. At event 618, the customer uses an input device, typically a remote control, to select a product for purchase, resulting in a product order page (not shown). The product order page can have a number of fields. The fields can include selection of product options, such as color, size, or model, etc. For example, the product order page may be custom generated to have one or more dropdown menu for the selectable product options, so the user does not need to manually type in the product option. In some example embodiments, at least some of the fields are pre-populated based on pre-selected settings, such as payment method and shipping preferences. In some example embodiments, some of this information may already be known by the telecommunications provider through the telecom provider customer database 152 (FIG. 1). Some of the fields may require inputs, and/or some of the pre-populated fields may be changed by the customer to new values.

At event 620, the customer uses an input device to select payment method. In some example embodiments, this field is pre-populated based on pre-configured settings. At event 622, the customer uses an input device to select shipping preference. In some example embodiments, this field is pre-populated based on pre-configured settings. At event 624, the customer uses an input device to confirm the selections (confirming the order). In some example embodiments, there is sufficient pre-populated information that the user merely needs to view and confirm the order requiring minimal or no selection of any of the options or fields. This may also minimize potential errors in ordering. The customer then confirms the order using an input command.

At event 626, the content management server 102 sends a payment request to the selected payment preference, for example to the particular payment processing module(s) 120 (FIG. 1). At event 628, the content management server 102 receives confirmation of successful payment (or declining of payment, as applicable). At event 630, the content management server 102 sends the order for fulfillment, resulting in an order record at event 632. In some example embodiments, the order is sent to the shopping channel ordering system 132, typically operated by the same content source 112 (FIG. 1). At event 634, the content management server 102 sends confirmation of the order success to the set-top receiver 108 for display of the confirmation to the customer.

In other example embodiments, note that completion of the potential order can be saved and completed later, such as using a shopping cart system.

Referring to event 614, note that the customer and/or vendor can pre-configure the billing preferences and/or shipping preferences using custom user interface pages, which may be generated by the content management server 102 and sent to the client device 106. In some example embodiments, the customer portal 150 (FIG. 1) may be used to pre-configure such information, using any device having a suitable network connection.

In some example embodiments, the companion device 110 is also configured to perform at least some or all aspects of the method 600. For example, metadata and user interface pages may be sent to the companion device 110 while the user is watching the video through the set-top receiver 108. The companion device 110 may be used to initiate and complete the purchase order of the product, by referencing the received metadata, for example.

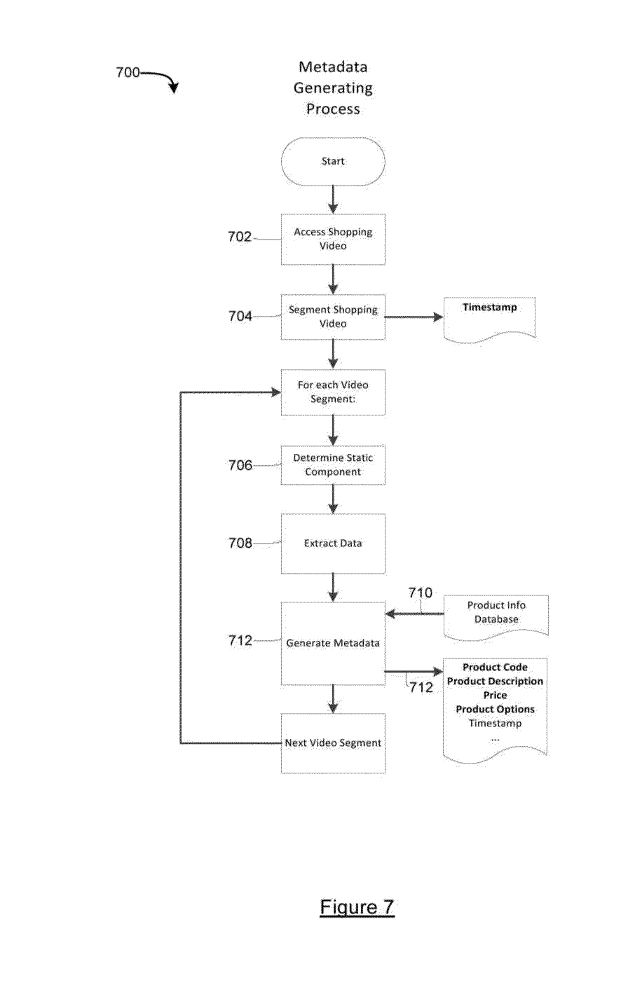

FIG. 7 illustrates a flow diagram of a method 700 for generating metadata from video content, in accordance with an example embodiment. In some example embodiments, the method 700 is at least part of event 502 (FIG. 5) for generating of metadata for the shopping video content. In some example embodiments, this is performed by the content management server 102 (FIG. 1).

As shown in FIG. 7, in some example embodiments, the method 700 can begin at event 702 wherein the content management server 102 accesses a shopping video content file, which is used to promote a product for sale. In some example embodiments, event 702 includes receiving the video content file from the content source 112 (FIG. 1). The video file may or may not already contain some metadata as populated by the content source 112. In some example embodiments, event 702 includes accessing the video content file from memory.

Referring now to event 704, the video content file is sometimes received from the content source 112 (FIG. 1) as shopping channel content for a plurality of sequential products. For example, the entire video content file may contain e.g. 24 hours of content, while each product can be associated with e.g. a 20 minute episode of the video content file. At event 702, the content management server 102 may segment the video content file into individual video segments (episodes). Suitable segmentation algorithms may be used, such as by determining breaks in programming, fade out, fade in, time tags, etc. Event 702 also includes storing the separate video segments in memory. The time of each video segment is also determined and saved. For example, for a 24 hour video content file, the first product segment may be denoted as 0:00 while the second product segment may be denoted as 0:20. Other timestamps may be used, such as the actual broadcast date and time of the video broadcast. The content management server 102 may then tag each video segment with the metadata generated by the method 700, including the timestamp of the video. The content management server 102 may subsequently receive a communication which references the time of the particular video (e.g. by reference to the metadata), and in response send the requested the video segments to the set-top receiver 108 (FIG. 1) for display.

For event 706 and subsequent events, each video segment and their respective product(s) may be processed individually. At event 706, the method 700 includes the content management server 102 determining a static component of the video content between at least some consecutive frames of the video content. As illustrated above with respect to FIG. 3, for example, the video content can include the static component 302 as well as the dynamic component 304 between at least some consecutive frames. In one example embodiment of event 706, determining of the static component includes comparing at least some consecutive frames and determining which regions do not change, or which regions are reserved windows for displaying static information, or which only change periodically (e.g. at least about every 30 seconds or so).

The determined static component can be defined as a static region. For example, the static region can be defined by pixel co-ordinates or other co-ordinates. For rectangular static regions, the co-ordinates can be defined by one or more of the diagonal pixels, as would be understood in the art. In some example embodiments, the co-ordinates may be provided by the content source 112 or may be provided in existing metadata of the original video file or stream.

At event 708, the content management server 102 extracts data from the video content file in relation to one of the products from the static component. The extracted data can include text or images. For example, at least product identifying information is extracted from the static component. Product identifying information may include, for example, text of the product name or the product code. Additional information may also be extracted, such as price information, product options information, and payment options information. In some example embodiments, optical character recognition (OCR) is used to extract the text.

In some example embodiments, referring still to event 708, images such as an image of the product or company logo may also extracted from the static component, and saved as an image file.

At event 710, additional product information is accessed, for example from the product information database 114, from memory, or from third party websites such as the official website of the product, review websites, vendor websites, etc. For example, in some example embodiments only product identifying information may need to be obtained from the static component. This product identifying information may then be used as a search term or identifier to access more reliable (cleaner) or more comprehensive information from the relevant sources or databases. Various methods for search disambiguation based on imperfect search terms would be understood in the art.

At event 712, the method 700 includes generating metadata based from at least the extracted data. The metadata further includes a reference time of the video segment, as described above in event 704. The video segments are then tagged with the metadata. The method 700 may be performed (repeated) to generate metadata for each video segment, for each product.

One example XML metadata schema is as follows: Product code, Product name, Options, Price, Payment Options, Time. For Payment Options, reference to “Easy Pay” can include payment ability through a billing account with the telecommunications provider. For example, one example XML metadata for a product is as follows: Product 1: Code 509-059, “Magic Mat”, Colours Blue/Grey, Price $69.99, Sale Price $49.99, Easy Pay=Y, on-screen from 20:00-20:27. For example, another example XML metadata for a product is as follows: Product 2: Code 509-624, “Earth Bright™ All Purpose Natural Cleaner 2 Pack”, No options, Price $29.99, Easy Pay=N, on-screen from 20:29-20:46.

FIGS. 8 and 9 will now be described in greater detail. Referring to FIG. 8, as shown in the side panel of the static component 804, there are images which have extractable data, such as text for product code (“583-489”), product name (“Guillaume Washable Suede Casual Chic Jacket”), original price ($219.90), shipping and handling price (“$8.98”), present price (“$149.90”), and payment price (“6 payments of $24.98”). Referring to the bottom banner 806, there are images which have extractable data, such as text for phone number (“1-888-2020-888”), web domain (“theshoppingchannel.com”), options (“Lipstick Red: 2X, 3X, Yellow: 2X, 3X”), image of shopping channel logo (“SHOP—the Shopping Channel”), image of product logo (“GUILLAUME”), and associated text from the logos.

Referring to FIG. 9, as previously described the static component can display different product information of the same product than from FIG. 8, which can change periodically (e.g. every 30 seconds, for example). Referring to FIG. 9, as shown in the side panel of the static component 904, there are images which have extractable data, such as text for features (“front pockets, fully lined”). The remaining information may be the same as the previous frame 800 (FIG. 8), such as product code and price. In the bottom banner, there may be different options (“Black: XS, Small, Medium, 2X”) than from the previous frame 800 (FIG. 8).

In some example embodiments, the static region remains static for all of the frames of the particular video segment for a product.

In accordance with some example embodiments, it would be appreciated that if the video content is accessed using a personal video record (PVR) application of the set-top receiver 108, the user may still attempt to initiate a purchase request using the remote control. Upon doing so, the metadata can be used by the set-top receiver 108 to reference the time of the currently watched video when initiating the purchase request to the content management server 102.

It is readily apparent that at least some aspects of the systems and methods of some example embodiments may not be limited to television devices, and that the system and method may be utilized in other devices, such as handheld devices, mobile devices, etc. As well, the application based solution may be utilized by various platforms such as Cable TV, IPTV, Mobile TV, etc. The configuration of the system in FIG. 1 is only one example system, and other configurations having different variations of network components may be suitable to perform the general functionality of the system.

In accordance with an example embodiment, there is provided a method for distributing content from a head-end server to a set-top receiver over a distribution network, the head-end server including one or more modules configured to access product information, to access customer information specific to the set-top receiver, and to process purchase requests, the method comprising: accessing video content in relation to at least one product; determining a static component of the video content between at least some consecutive frames of the video content, the video content further including a dynamic component between the at least some consecutive frames; extracting data in relation to one of the products from the static component; generating metadata based from at least the extracted data, the metadata further including a reference time of the one of the products within the video content; and sending the video content and the metadata to the set-top receiver over the distribution network.

In an example embodiment, the extracted data comprises at least one of: i) extracted text from the video content, and ii) an extracted image from the video content.

In an example embodiment, the method further comprises receiving at the head-end server a communication which references the metadata in relation to a purchase request of one of the products.

In an example embodiment, the video content includes a sequence of videos each being in relation to an associated product, and the method further comprises: segmenting the video content into separate video segments for each associated product; storing the separate video segments in memory; and in response to a communication which references the metadata, sending a requested one of the video segments to the set-top receiver for display by the set-top receiver.

In an example embodiment, the method further comprises sending information to the set-top receiver for a custom shopping interface page in relation to the one of the products.

In an example embodiment, the method further comprises sending the information for the custom shopping interface page for automatic display by the set-top receiver of the custom shopping interface page between sequential videos of the video content.

In accordance with another example embodiment, there is provided a server for distributing content over a distribution network to a set-top receiver, comprising: memory, one or more modules configured to access product information, to access customer information specific to the set-top receiver, and to process purchase requests, and a processor. The configured is to: access video content in relation to at least one product, determine a static component of the video content between at least some consecutive frames of the video content, the video content further including a dynamic component between the at least some consecutive frames, extract data in relation to one of the products from the static component, generate metadata based from at least the extracted data, the metadata further including a reference time of the one of the products within the video content, and send the video content and the metadata to the set-top receiver over the distribution network.

In accordance with another example embodiment, there is provided a non-transitory computer-readable medium containing instructions executable by a processor for distributing content from a head-end server over a distribution network to a set-top receiver, the head-end server including one or more modules configured to access product information, to access customer information specific to the set-top receiver, and to process purchase requests. The instructions include: instructions for accessing video content in relation to at least one product; instructions for determining a static component of the video content between at least some consecutive frames of the video content, the video content further including a dynamic component between the at least some consecutive frames; instructions for extracting data in relation to one of the products from the static component; instructions for generating metadata based from at least the extracted data, the metadata further including a reference time of the one of the products within the video content; and instructions for sending the video content and the metadata to the set-top receiver over the distribution network.

In the described methods, the boxes may represent events, steps, functions, processes, modules, state-based operations, etc. While some of the above examples have been described as occurring in a particular order, it will be appreciated by persons skilled in the art that some of the steps or processes may be performed in a different order provided that the result of the changed order of any given step will not prevent or impair the occurrence of subsequent steps. Furthermore, some of the messages or steps described above may be removed or combined in other embodiments, and some of the messages or steps described above may be separated into a number of sub-messages or sub-steps in other embodiments. Even further, some or all of the steps may be repeated, as necessary. Elements described as methods or steps similarly apply to systems or subcomponents, and vice-versa. Reference to such words as “sending” or “receiving” could be interchanged depending on the perspective of the particular device.

While some example embodiments have been described, at least in part, in terms of methods, a person of ordinary skill in the art will understand that some example embodiments are also directed to the various components for performing at least some of the aspects and features of the described processes, be it by way of hardware components, software or any combination of the two, or in any other manner. Moreover, some example embodiments are also directed to a pre-recorded storage device or other similar computer-readable medium including program instructions stored thereon for performing the processes described herein. The computer-readable medium includes any non-transient storage medium, such as RAM, ROM, flash memory, compact discs, USB sticks, DVDs, HD-DVDs, or any other such computer-readable memory devices.

Although not specifically illustrated, it will be understood that the devices described herein include one or more processors and associated memory. The memory may include one or more application program, modules, or other programming constructs containing computer-executable instructions that, when executed by the one or more processors, implement the methods or processes described herein.

The various embodiments presented above are merely examples and are in no way meant to limit the scope of this disclosure. Variations of the innovations described herein will be apparent to persons of ordinary skill in the art, such variations being within the intended scope of the present disclosure. In particular, features from one or more of the above-described embodiments may be selected to create alternative embodiments comprises of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

1. A method for distributing content from a head-end server to a set-top receiver over a distribution network, the head-end server including one or more modules configured to access product information, to access customer information specific to the set-top receiver, and to process purchase requests, the method comprising:
accessing video content in relation to at least one product;
determining a static component of the video content between at least some consecutive frames of the video content, the video content further including a dynamic component between the at least some consecutive frames;
extracting data in relation to one of the products from the static component;
generating metadata based from at least the extracted data, the metadata further including a reference time of the one of the products within the video content; and
sending the video content and the metadata to the set-top receiver over the distribution network.

2. The method as claimed in claim 1, wherein the extracted data comprises at least one of: i) extracted text from the video content, and ii) an extracted image from the video content.

3. The method as claimed in claim 1, further comprising receiving at the head-end server a communication which references the metadata in relation to a purchase request of one of the products.

4. The method as claimed in claim 3, wherein the purchase request is received from the set-top receiver.

5. The method as claimed in claim 3, wherein the purchase request is received from a client device which is not the set-top receiver.

6. The method as claimed in claim 1, wherein the metadata is generated based from accessing the product information using the extracted data.

7. The method as claimed in claim 1, wherein the product information is accessed from a server.

8. The method as claimed in claim 1, further comprising tagging the video content with the metadata.

9. The method as claimed in claim 1, wherein the static component is a display region on at least some video frames of the video content.

10. The method as claimed in claim 9, further comprising comparing at least some consecutive frames of the video content to determine the display region.

11. The method as claimed in claim 1, wherein the video content includes a sequence of videos each being in relation to an associated product, further comprising:
segmenting the video content into separate video segments for each associated product;
storing the separate video segments in memory; and
in response to a communication which references the metadata, sending a requested one of the video segments to the set-top receiver for display by the set-top receiver.

12. The method as claimed in claim 11, wherein metadata is generated for each associated product, including associated reference times of each associated product within the video content.

13. The method as claimed in claim 1, further comprising sending information to the set-top receiver for a custom shopping interface page in relation to the one of the products.

14. The method as claimed in claim 13, further comprising sending the information for the custom shopping interface page for automatic display by the set-top receiver of the custom shopping interface page between sequential videos of the video content.

15. The method as claimed in claim 13, wherein the information for the custom shopping interface page is sent to the set-top receiver as a consequence to the set-top receiver receiving an input command.

16. The method as claimed in claim 13, wherein the custom shopping interface page contains at least one or all of: the customer information, billing information, product information of the one of the products, product rating, similar product information, previous product information, video segment request of the one of the products, and a selectable purchasing option.

17. The method as claimed in claim 13, wherein the information for the custom shopping interface page comprises mark-up information.

18. The method as claimed in claim 1, further comprising sending to the set-top receiver information for a custom security interface page for authenticating a user at least based on the customer information.

19. The method as claimed in claim 1, further comprising sending to the set-top receiver information for a custom billing interface page for setting billing preferences.

20. The method as claimed in claim 1, wherein the head-end server and the distribution network are operated by a telecommunications provider, wherein the head-end server is configured to process a purchase request by billing at least one of: a billing account with the telecommunications provider, a credit card system, a debit card system, a loyalty program, and a mobile wallet.

21. The method as claimed in claim 1, wherein the generated metadata further comprises at least one of: product identification information, price information, product options information, and payment options information.

22. The method as claimed in claim 1, wherein the static component is a semi-transparent region over the dynamic component.

23. A server for distributing content over a distribution network to a set-top receiver, comprising:
memory;
one or more modules configured to access product information, to access customer information specific to the set-top receiver, and to process purchase requests; and
a processor configured to:
access video content in relation to at least one product;
determine a static component of the video content between at least some consecutive frames of the video content, the video content further including a dynamic component between the at least some consecutive frames;
extract data in relation to one of the products from the static component;
generate metadata based from at least the extracted data, the metadata further including a reference time of the one of the products within the video content; and
send the video content and the metadata to the set-top receiver over the distribution network.

24. A non-transitory computer-readable medium containing instructions executable by a processor for distributing content from a head-end server over a distribution network to a set-top receiver, the head-end server including one or more modules configured to access product information, to access customer information specific to the set-top receiver, and to process purchase requests, the instructions comprising:
instructions for accessing video content in relation to at least one product;
instructions for determining a static component of the video content between at least some consecutive frames of the video content, the video content further including a dynamic component between the at least some consecutive frames;
instructions for extracting data in relation to one of the products from the static component;
instructions for generating metadata based from at least the extracted data, the metadata further including a reference time of the one of the products within the video content; and
instructions for sending the video content and the metadata to the set-top receiver over the distribution network.
